(19) United States
(12) Patent Application Publication
(10) Pub. No.: US 2015/0165499 A1
(43) Pub. Date: Jun. 18, 2015

(54) Inert Material, A Production Method Thereof From Waste Materials And Industrial Uses Thereof

(71) Applicants: Velaworks s.r.o., Kosice (SK); UNIVERSITÀ DEGLI STUDI DI BRESCIA, Brescia BS (IT); CONTENTO TRADE S.R.L., Rigolato UD (IT)

(72) Inventors: Elza Bontempi, Brescia (IT); Laura Depero, Brescia (IT); Alberto Bosio, Brescia (IT); Alessandra Gianoncelli, Brescia (IT); Flavio Cioffi, Rigolato (IT)

(21) Appl. No.: 14/418,974

(22) PCT Filed: Aug. 1, 2013
(86) PCT No.: PCT/IB2013/056325

§ 371 Date: Feb. 2, 2015

(30) Foreign Application Priority Data
Aug. 3, 2012 (IT) MI2012A001382

(51) Int. Cl. B09B 3/00; B01J 20/30; C02F 1/28; C04B 35/14; C08K 3/00; B01J 20/10; B01D 39/20

(52) U.S. Cl. CPC B09B 3/0041; B01J 20/103; B01J 20/3071; B01J 20/3078; B01J 20/3085; B01D 39/2003; C04B 35/14; C08K 3/00; B01D 39/2068; C02F 1/281

(57) ABSTRACT

The present invention concerns a material obtained by processing fragmented waste, waste material containing silica, and possibly ashes of flue-gas desulphurisation plants (FGD), coal ashes (CA), water and alcohols. The invention also concerns the method of preparing the material and the uses of such material in construction (also for manufacturing tiles) and in other fields in which it can be introduced as an inert, like for example in materials such as plastics, rubbers, polyurethanes (for example for increasing fire proof) etc., and for its absorbing properties like for example of dyes and soaps, as a filter, for example for waste water in water treatment plants.

### FIELD OF THE INVENTION

The present invention concerns an inert material obtained from processing waste material, the relative production method and also the uses of this material in the industrial field.

### STATE OF THE ART

Waste material (flue ashes) are usually generated during the production of energy, for example in pit coal or lignite fed power plants, in waste incinerators, as by-products of industrial processes, for example in blast furnaces, like for example phosphorous and steel slag. Waste material can also comprise products from the rice refining (rice husks or hulls and the ashes thereof (RHA)), the waste products in the industry that produces silica that may or may not be used for food purposes and “silica fume” which is a by-product of the production of silicon based metal alloys.

Usually, waste disposal treatment comprises the use of landfills or enclosure of waste in cement, in concrete and in other construction materials. This approach, however, is unsatisfactory due to the inadequate leaching-resistant properties of the final products.

A further waste disposal strategy is indicated in U.S. Pat. No. 5,626,552 (Nomura et al.) encompassing that the waste incineration products are mixed with a solution of soluble glass and are then treated thermally in order to obtain a solid product. This approach however can be onerous in terms of energy because of the huge amount of waste emitted.

More recently Applicant filed WO2011/079921, describing an innovative technology for the inertization of fly ashes, envisaging mixing waste containing heavy metals, at room temperature, with two further waste ashes (those from coal, and from desulphurisation) that, together with commercial colloidal silica, forms a stable solid product that does not release polluting substances, such as heavy metals, in the environment.

In terms of the environment, this last method seems to be the most advantageous but it is expensive due to the use of large amounts of commercial colloidal silica.

The main purpose of the present invention is that of solving the above technical problems of the state of the art.

The present invention further relates to the obtainment of an inert and/or absorbing material that can be used again in industry.

### SUMMARY OF THE INVENTION

These and other purposes are achieved with the inert material according to the present invention obtained by processing waste or scrap material (A) containing heavy metals and/or organic substances (like for example dioxins, furans and PCBs—polychlorinated phenyls), waste material containing silica (D), and possibly: ashes of flue-gas desulphurisation (FGD) plants (B), coal ashes (CA) (C), water and alcohols (E).

The present invention further relates to the method for preparing the aforementioned material, which in particular comprises the following steps:

a) mixing the material (A), possibly already in the fragmented form, with the material (D), possibly with the materials (B), (C), and (E) at a temperature of between 0° and 250° C., until a homogeneous mixture has been obtained;
b) solidifying the mixture until an inert material has been obtained;
c) possibly washing with water the product obtained for removing water soluble halides, carbonates and/or nitrates, that can be recovered from the washing water. The present invention further concerns the several uses of this material in the construction industry (also for tiles manufacture) and in other fields in which it can be introduced as an inert, like for example in plastic materials, in rubber, in polyurethanes (for example to increase fire proof) etc., and for its absorbing properties like for example of dyes and soap, as a filter, for example of waste water in water treatment plants.

### DESCRIPTION OF THE FIGURES

FIG. 1 shows an analysis of the absorbance of a fruit juice before and after dye absorption on the inert material according to the present invention.

FIG. 2 represents an XRD spectrum, at room temperature, of the material of the present invention, obtained with the method of the invention using waste silica and in particular silica from rice husk, indicated with COSMOS RICE and that obtained with the method described in WO2011079921 and identified with COSMOS LUDOX.

### DETAILED DESCRIPTION OF THE INVENTION

For the purposes of the present invention the definition “total weight of the waste or scrap material” indicates the total weight of the waste or scrap material (flue ashes) (A), (D) and possibly (B), (C), and (E).

The material obtained according to the present invention typically comprises by weight based on the total weight of the material:

from 1% to 80% of amorphous material and, as a function the heat treatment possibly carried out,
from 1% to 10% of crystalline silica comprising quartz and cristobalite,
from 0% to 30% of sulphate or calcium sulphite (possibly hydrates),
from 0% to 60% of calcium carbonate, and is characterised in that it can contain various metals, in low concentrations. For example Ti<1%, V<1%, Cr<1%, Mn<1%, Fe<5%, Ni<1%, Cu<1%, Zn<1%, As<0.5%, Se<1%, Br<1%, Rb<1%, Pb<0.5% by weight over the total weight of the material. The Applicant has surprisingly found that the material obtained with the process according to the present invention in particular obtained from ashes of rice husk, is different from that obtained by using colloidal silica and with the method described in WO-A-2011A1079921, for the presence of cristobalite, that, on the other hand, is absent in the material obtained with the method of the prior art, as highlighted in the XRD spectrum shown in FIG. 2.

In case the inert material of the invention is not washed, it can contain soluble salts at concentrations up to 50%.

The metals contained in the waste or scrap material (A) are potentially: silver, arsenic, barium, bismuth, cadmium, chromium, iron, manganese, nickel, lead, copper, selenium, and/or zinc whereas the organic substances can be mainly represented by dioxins, furans and PCBs.

The waste or scrap material (A) can be added in concentrations of between 1 and 90% in an already fragmented form obtained by milling, powdering, cutting or the like if the waste or scrap material is a solid material with large dimensions that could otherwise prevent an acceptable homogenization of the various reagents described later on in the present description. In alternative the fragmentation can occur directly in the mixing step of the other components.

The FGD residue or material (B) is a product that is typically formed in reduction processes of emissions of sulphur oxides from the exhaust gases system of an incinerator. The physical nature of this material varies between humid mud and dry powdery material according to the process that generated it. In some cases, therefore, the method also comprises a drying step of this waste. Sometimes, partial drying is advantageous in cases waste material is muddy, or is in the form of slime, and optionally in cases the halides indicated below result diluted in an unacceptable manner in the waste material. The mass of ashes from desulphurisation, that are possibly added to the mixture of step (a), must be ideally comprised between 5 and 50% by weight of the total waste material. According to an even more advantageous modality, the amount of the FGD ashes is comprised between 6 and 20% of the weight.

Coal ashes or material (C), which are possibly added to the mixture of step (a) represent the solid particulate matter recovered from systems for separating powders from combustion fumes in thermal power plants using previous solid fuel. These are formed by micron sized sphere-shaped particles, having a generally amorphous structure, resulting from melting in a boiler and subsequently re-condensing, along the fumes lines, inert silica-alumina fraction present in powdered coal used for generating steam.

The mass of coal ashes are ideally comprised between 4 and 60% of the total weight of the waste material. According to an even more advantageous modality, the mass of the CA ashes is of between 4 and 15% of the total weight of the waste material.

The method moreover envisages the presence of the waste material (D) containing silica like for example “silica fume”, waste silica, by-product of plants for processing silica (also colloidal that may or may not be for food purposes), waste products of rice industry before (husks and hulls) and after incineration (RHA: rice husk ash, or rather rice hull ashes).

The amount of waste material containing silica must be comprised between 5 and 60% of the total weight of the waste material.

Finally, the amount of aqueous solution (E) is preferably comprised between 10 and 70% by weight of the waste material to be treated; in other words the amount of aqueous solution is evaluated with respect to the total mass of the overall content, therefore in a case by case way, in order to obtain a mixture with mechanical properties suitable for the subsequent steps of the method of the invention. In other words the mixture between aqueous solution and the waste material must be so sufficiently liquid as to make it suitably workable, but not excessively liquid since in this case the solidification and drying step thereof would be difficult.

The procedure foresees that waste material (A), together with waste material containing silica (D), and possibly ashes from desulphurisation (B), coal ashes (C), and aqueous solution (E) possibly comprising alcohols, are mixed until a substantially homogenous mixture is obtained. The mixing step can occur in a continuous stirring tank reactor (CSTR) for the time necessary to obtain a homogeneous mixture. The time may vary between 10 minutes and a few hours according to the amount of the reagents to be used and the mixing speed of the reactor. According to preferred embodiments mixing and fragmenting steps occur at the same time inside the same reactor.

In some cases the kinetics of the reaction is promoted by boiling (100° C.) the mixture during the mixing step.

In some cases a sufficient amount of alcohol is added for promoting the dechlorination of the organic compounds, like for example methanol or ethanol.

In a subsequent step of the method according to the present invention, the mixture is solidified to give an inert material, in which the heavy metals are trapped inside a metal-silica compound, that is substantially insoluble and therefore it cannot dissolve or propagate in the environment during use and the organic substances (like dioxins, furans and PCBs) are reduced through a dechlorination reaction.

The solidifying step comprises a step of resting the mixture at a temperature lower than 40° C.

For this reason, and in an innovative manner, the method of the present invention makes it possible to dispose waste material containing heavy metals and/or organic substances in a cost-effective manner with the only burden consisting of mixing and possibly boiling the mixture obtained.

Indeed solidification occurs at room temperatures of between 10 and 40° C., as a function of the location and the season, preferably between 20 and 25° C., alternatively at atmospheric pressure.

The resting step must last at least 24 hours. According to further alternatives, the resting step is comprised between 24 and 120 hours.

The starting reaction mixture used in step a) of the method according to the present invention can contain soluble salts. Some of them can be chlorides, fluorides, bromides, iodides, nitrates and sulphates.

It is important to note that soluble salts in addition to causing obvious problems in terms of corrosion to the equipment, drastically limit the possible uses of the semi-finished product since the latter is a material that could be corrosive. According to this embodiment, the method relative to the invention can subsequently comprise a step of removing water soluble salts through a step of washing with water (due to its high availability and to its low cost). The step of recovering the salts (for example halides) comprises a step of mechanical ultra-filtering, centrifuging, decanting, membrane separating, evaporating, distilling, carrying out electrolysis and/or crystallising. This removal step moreover comprises the step of removing soluble and/or leachable compounds, for example sulphates, nitrates and/or carbonates, and optionally also a step of recovering these compounds.

In this way, the inert material thus obtained has a greater variety of possible uses with respect to the solid products conventionally obtained.

As an example, the inert material according to the present invention can be used as a construction material, for example as a tile, brick, as a filler (in powder form), for example of polymers or different matrices to improve mechanical properties thereof, as an inert substance or a generic additive for rubber, plastic, technopolymers, asphalt, concrete and cement.

In particular it can also be used as an inorganic filler in polyurethanes for increasing fire proof.

The new inert material can moreover be used as a filter for purifying for example waste or industrial water.

It has indeed been verified that the new material has the capability of absorbing many molecules and amongst them commercial dyes, soaps etc. for example by immersion of this material in a solution containing food dyes.

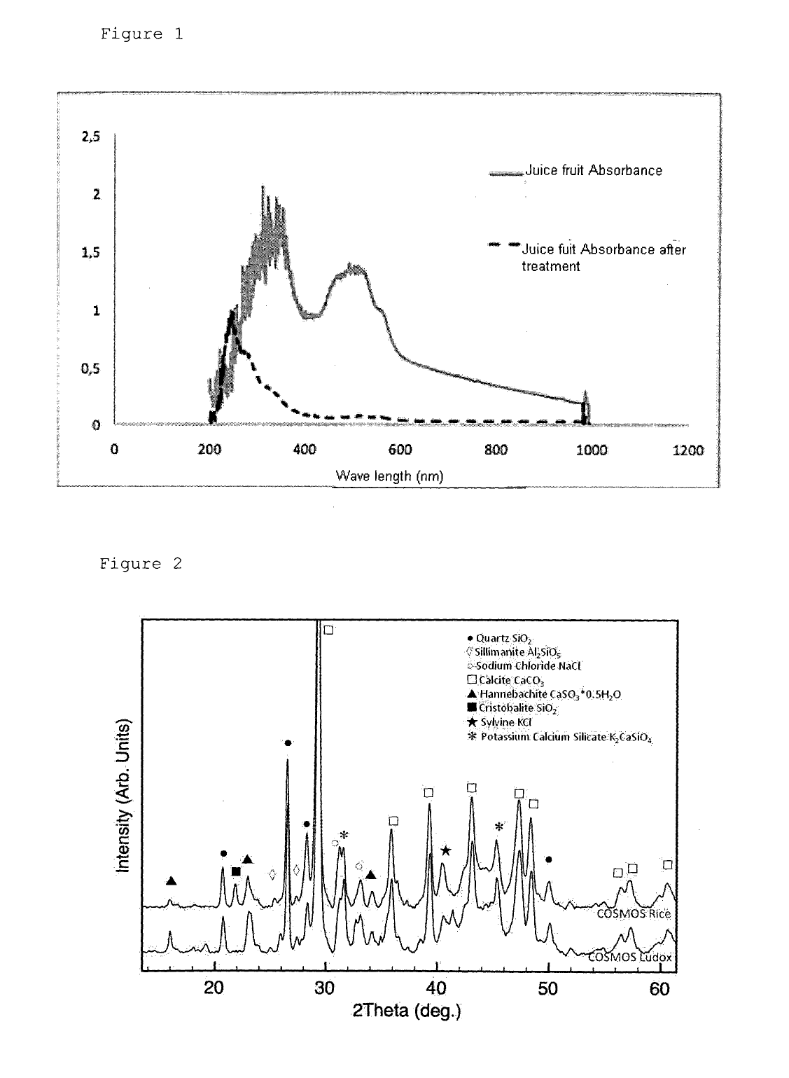

As it results from spectrometric analysis shown in FIG. 1, the material has absorbing characteristics.

We report herewith, for illustrative but not limitative purposes, some examples of the process for preparing the inert material according to the present invention.

In the following examples, in order to demonstrate the immobilization of heavy metals, leaching tests were carried out according to standard UNI EN 12457—2:2004 and the tables show the results of the TXRF analyses on the eluate.

### Example 1

The semi-finished product (inert material) was prepared by using silica fume.

| | FA (g) | FGD (g) | Silica fume (g) | H₂O (g) |
|---|---|---|---|---|
| 1 | 40 | 40 | 40 | 120 |
| 2 | 30 | 30 | 60 | 180 |
| 3 | 50 | 50 | 25 | 120 |

FA=flue ashes, FGD=flue-gas desulphurisation ashes Release tests were carried out on 20 g of powder in 200 ml of H₂O, shaken for 2 h.

TXRF analysis was carried out on 3 samples per solution.

For each sample 3 drops of 5 μl of solution were used.

The analysis on the flue ashes is shown in table 1.

The TXRF analysis on the inert materials 1, 2 and 3 are shown in tables 2, 3 and 4, respectively.

Also a TXRF analysis was carried out on the eluate of the Silica fume material, and the numerical data of the same analysis are shown in table 5.

TABLE 1
flue ashes (FA)

| Element | Conc./(mg/l) |
|---|---|
| S | 11.04 |
| Cl | 5128.89 |
| K | 1287.75 |
| Ca | 3258.96 |
| Fe | 2.85 |
| Zn | 4.95 |
| Br | 81.17 |
| Sr | 4.52 |
| Pb | 21.37 |

TABLE 2
(Inert material 1)

| Element | Conc./(mg/l) |
|---|---|
| S | 37.45 |
| Cl | 4305.31 |
| K | 883.15 |
| Ca | 2502.21 |
| Fe | 1.31 |
| Zn | 0.65 |
| Br | 51.7 |
| Sr | 19 |
| Pb | <0.003 |

TABLE 3
(inert material 2)

| Element | Conc./(mg/l) |
|---|---|
| S | 2.582 |
| Cl | 202.676 |
| K | 32.044 |
| Ca | 107.261 |
| Fe | 0.058 |
| Zn | 0.008 |
| Br | 3.14 |
| Sr | 0.531 |
| Pb | <0.001 |

TABLE 4
(inert material 3)

| Element | Conc./(mg/l) |
|---|---|
| S | 1.54 |
| Cl | 2966.54 |
| K | 535.88 |
| Ca | 2013.45 |
| Fe | 0.7 |
| Ni | 0.15 |
| Zn | 0.19 |
| Br | 27.44 |
| Sr | 9.05 |
| Pb | 0.23 |

TABLE 5
Silica fume

| Element | Conc./(mg/l) |
|---|---|
| S | 10.11 |
| Cl | 2.963 |
| K | 9.172 |
| Ca | 33.972 |
| Ti | 0.036 |
| Mn | 0.055 |
| Fe | 0.111 |
| Co | 0.022 |
| Ni | 0.038 |
| Cu | 0.02 |
| Zn | 0.066 |
| Br | 0.056 |
| Sr | 0.104 |
| Pb | 0.024 |

### Example 2

Finished inert material was prepared by using rice husk, the components thereof are shown in the following table.

| | FA (g) | FGD (g) | Rice husk (g) | H₂O (g) |
|---|---|---|---|---|
| 1 | 48.5 | 15 | 82.5 | 250 |

The reaction was carried out in a reactor at 100° C. for one hour.

The TXRF analysis of the starting mixture is shown in table 6. Analogously, the TXRF analysis of the inert material obtained is shown in Table 7.

TABLE 6
flue ashes (FA)

| Element | Conc./(mg/l) |
|---|---|
| S | 12.46 |
| Cl | 3339.77 |
| K | 369.61 |
| Ca | 3353.25 |
| Cu | 0.49 |
| Zn | 19.25 |
| Br | 76.42 |
| Rb | 2.42 |
| Sr | 6.02 |
| Ba | 5.73 |
| Pb | 52.64 |

TABLE 7
Inert material

| Element | Conc./(mg/l) |
|---|---|
| S | 44.71 |
| Cl | 927.59 |
| K | 178.30 |
| Ca | 867.09 |
| Zn | <0.001 |
| Cu | 0.65 |
| Br | 12.80 |
| Rb | 0.38 |
| Sr | 5.58 |
| Ba | 0.42 |
| Pb | <0.001 |

### Example 3

The material was prepared by using rice husk ashes (RHA). The starting mixture consisted of the following components.

| | FA (g) | FGD (g) | RHA (g) | H₂O (g) |
|---|---|---|---|---|
| 1 | 48.5 | 15 | 17 | 200 |

The reaction was carried out in a reactor at 100° C. for one hour.

The TXRF analysis on the flue ashes is in table 8.

The TXRF analysis of the inert material gave the results shown in table 9

TABLE 8
flue ashes (FA)

| Element | Conc./(mg/l) |
|---|---|
| Cl | 12408.71 |
| K | 2404.43 |
| Ca | 9915.04 |
| Fe | 3.75 |
| Cu | 0.89 |
| Zn | 25.82 |
| Br | 168.15 |
| Rb | 5.08 |
| Sr | 12.47 |
| Ba | 15.91 |
| Pb | 63.18 |

TABLE 9
Inert material

| Element | Conc./(mg/l) |
|---|---|
| Cl | 1487.73 |
| K | 132.61 |
| Ca | 869.08 |
| Fe | 0.35 |
| Zn | <0.001 |
| Br | 51.27 |
| Rb | 1.75 |
| Sr | 10.05 |
| Ba | 0.53 |
| Pb | <0.001 |

In this case the equivalent toxicity, due to organic substances, was reduced to 30% of the initial value.

### Example 4

The inert material was prepared by using silica extracted from rice husk ashes. The reaction mixture had the following composition shown in the table.

| | | | | RHA | |
|---|---|---|---|---|---|
| | FA | FGD | | silica | H₂O |
| | (g) | (g) | CA (g) | (g) | (g) |
| 1 | 65 | 20 | 15 | 236.15 | 100 |

The reaction was carried out in a reactor at room temperature for one hour.

The TXRF analysis of flue ashes gave the results shown in table 10.

The TXRF analysis of the inert material gave the results shown in table 11.

TABLE 10
flue ashes (FA)

| Element | Conc./(mg/) |
|---|---|
| Cl | 12408.71 |
| K | 2404.43 |
| Ca | 9915.04 |
| Fe | 3.75 |
| Cu | 0.89 |
| Zn | 25.82 |
| Br | 168.15 |
| Rb | 5.08 |
| Sr | 12.47 |
| Ba | 15.91 |
| Pb | 63.18 |

TABLE 11
Inert material

| Element | Conc./(mg/l) |
|---|---|
| S | 203.72 |
| Cl | 2799.02 |
| K | 477.44 |
| Ca | 1104.47 |
| Cr | 0.87 |
| Zn | 0.14 |
| Ga | 1.00 |
| Br | 71.44 |
| Rb | 1.46 |
| Sr | 4.23 |
| Ba | 0.79 |
| Pb | <0.001 |

1. Inert and/or absorbent material obtained by processing waste material containing heavy metals (A) and/or organic polluting substances, waste material containing silica (D) and possibly ashes from flue-gas desulphurisation (FGD) plants (B), coal ashes (CA)(C), water and alcohols (E)
comprising by weight based on the total weight of the material:
from 1% to 80% of amorphous material,
from 1% to 10% of crystalline silica, comprising quartz and cristobalite
from 0% to 30% of calcium sulphite or sulphate (possibly hydrates),
from 0% to 60% of calcium carbonate,
from 0% to 20% of silicates,
the following metals, in the following concentrations: Ti<1%, V<1%, Cr<1%, Mn<1%, Fe<5%, Ni<1%, Cu<1%, Zn<1%, As<0.5%, Se<1%, Br<1%, Rb<1%, Pb<0.5% by weight over the total weight of the material.

2. Method for preparing a material according to claim 1 comprising the following steps:
a) mixing the material (A) possibly already in the fragmented form, with the material (D) and possibly with (B), (C), and (E) at a temperature of between 0 and 250° C. until a homogeneous mixture is obtained;
b) solidifying the mixture until an inert product is obtained;
c) possibly washing the product obtained for removing water soluble halides, carbonates and/or nitrates, that are recovered from the washing water.

3. Method according to claim 2, wherein in the step (a)
the material (A) is added in an amount of between 1 and 90% by weight over the total weight of the waste material
(D) is added in concentrations of between 15 and 60% by weight over the total waste material;
and possibly:
(B) is added in amounts of between 5 and 50% by weight over the total weight of waste material,
(C) is added in concentrations of between 4 and 30% by weight over the total weight of the waste material and
(E) is added in concentrations of between 10 and 70% by weight based on the total weight of the waste material.

4. Method according to claim 2, wherein step (a) is carried out at the boiling temperature of (E).

5. Method according to claim 2, wherein step (b) comprises a dechlorination reaction of the organic polluting substances in the presence of ash.

6. Method according to claim 2, wherein step (b) comprises a step of cooling between 0 and 40° C. and of resting for a time that is not shorter than 24 hours.

7-9. (canceled)

10. Filter comprising the inert and/or absorbent material according to claim 1.

11. Ceramics comprising the inert and/or absorbent material according to claim 1.

12. Tiles comprising the inert and/or absorbent material according to claim 1.

13. An inorganic filler for materials selected from plastics, rubbers, polyurethanes comprising the inert and/or absorbent material according to claim 1.

14. The filter according to claim 10 for absorbing polluting liquid material in civil and/or industrial waste and water treatment plants.
